(19) United States
(12) Patent Application Publication
(10) Pub. No.: US 2020/0017275 A1
(43) Pub. Date: Jan. 16, 2020

(54) CONTAINER FOR PHOTOSENSITIVE MATERIAL

(71) Applicant: MARPAZ TECHNOLOGIES LTD., Beer-Sheva (IL)

(72) Inventors: Idan HARPAZ, Beer-Sheva (IL); Oren MARKUS, Tel-Aviv (IL); Roy HARPAZ, Beer-Sheva (IL)

(21) Appl. No.: 16/485,471

(22) PCT Filed: Feb. 13, 2018
(86) PCT No.: PCT/IL2018/050163

§ 371 Date: Aug. 13, 2019

(30) Foreign Application Priority Data
Feb. 14, 2017 (IL) 250601

(51) Int. Cl. B65D 81/30; B65D 77/04; B65D 41/04

(52) U.S. Cl. CPC B65D 81/30; B65D 41/04; B65D 77/0493

(57) ABSTRACT

The present invention provides a 3-part container for holding photosensitive material while providing both light-protection to its content, as well as the possibility of observing its content when needed in a safe manner without the risk of spillage and exposure to air and contaminants.

### FIELD OF THE INVENTION

The present invention relates to light-protective containers designed to hold light-sensitive material. More particularly, the present invention is directed to a 3-part container providing light protection to its content, as well as the possibility of observing the content (e.g. assessing the amount) when needed in a simple manner without the risk of spillage and exposure to air and possible contaminants.

### BACKGROUND OF THE INVENTION

Containers such as test tubes, slides, wells, plates, bottles, columns, beakers, flasks, and other storage and/or reaction vessels are commonly used to store various materials, including photosensitive materials, drugs and analytes. Typically these containers are made from a translucent or transparent material to allow visual inspection, which make the contents of the containers susceptible to light. Accordingly, a delay in use of photosensitive materials stored in such containers can result in degradation of such photosensitive materials.

Accordingly, photosensitive materials are generally housed in colored glass containers, glass containers that have been treated with a UV-protectant, or in opaque plastic containers. When a photosensitive material is contained in a colored or UV-treated glass container, the user may view the contents therein, however, with some difficulty, yet the material within is still somewhat exposed to light. On the other hand, opaque containers do not offer the ability to see the contents held within. Further, light-protecting materials, including colorants such as carbon black and UV-protectants, which are typically used on glass containers, cannot be used on plastic containers, since these additives have a tendency to leach from the plastic material and contaminate the material contained therein. Many photosensitive materials become contaminated when exposed to these additives, rendering them useless.

Additionally, making the container opaque prevents visual inspection of its contents and prevents the possibility of knowing how much material remains therein. Visual inspection of the content of the container is beneficial both to verify the amount of fluid/material remaining within the container, as well as during usage of the material, e.g., to ensure that the content is clean and free of contaminants.

Another way to prevent exposure of a light-sensitive material to light is to enclose the container holding said light-sensitive fluid in a sealed opaque overwrap. However, these overwraps may tear, as well as prevent basic actions, e.g. placing the container in an upright position, centrifuge the container (with an overwrap), etc.

Often, to protect light-sensitive material from light, a person covers the container with a sheet of opaque material, e.g. aluminum foil. However, this improvised procedure requires that all persons handling said container be aware that it has to be light-protected, and often such a cover is misplaced or does not create a complete light block, e.g. due to a small undetected tear or inadequate covering. In addition, this might be somewhat suitable for personal and time-limited use, but is inadequate in large scale preparations, shipment of light-sensitive materials and long-term usage.

ES 2358409 describes two separate, unrelated systems for storing photosensitive material: one comprising an inner container with a lid and an outer opaque rigid container with another lid, and one comprising an inner container with a lid and an outer opaque flexible/deformable container.

U.S. Pat. No. 5,695,090 provides a portable container for medicine bottles that provides high impact protection and insulation, said container comprises: (i) a medicine bottle comprising a rigid bottle and a cap assembly; and (ii) a container comprising a lower sleeve and an upper cap, both with an impact resistant wall.

US 2010/0038273 describes a sleeve for surrounding a container.

EP 2351693 relates to a protective label for shielding a container's content from light, said container and label comprise at least two openings through which the light can penetrate, so that rotation of the label with respect to the container to align said openings enable looking therein.

As such, there remains a need for a light-protective container which allows the user to view the contents of photosensitive material contained therein, and that avoids the problem of currently used containers.

### SUMMARY OF INVENTION

The present invention provides a container for holding a photosensitive material, said container comprising: (a) an opaque rigid outer shell 101 having a sealed bottom-end and an open upper-end; (b) an inner rigid container 102 having a sealed bottom-end and an open upper-end, wherein at least part of said inner container 102 is transparent; and (c) an opaque lid 103 designed to connect and seal said inner container 102, wherein, when said lid 103 seals said inner container 102, and said inner container 102 is placed within said outer shell 101, said outer shell 101 interlocks with either said lid 103 or said inner container 102, and said lid 103 together with said outer shell 101 creates a light-impermeable casing.

The present invention provides a container for holding a photosensitive material, said container comprising: (a) a light-impermeable rigid outer shell 101 comprising a sealed bottom-end and an open upper-end; (b) an inner rigid container 102 comprising a sealed bottom-end and an open upper-end, wherein at least part of said inner container 102 is transparent; and (c) a light-impermeable lid 103 designed to screw onto and seal said inner container 102, wherein:
said light-impermeable rigid outer shell 101 and said inner container 102 comprise complementary protrusions 106 and grooves 107 designed to fit one another when said inner container 102 is inserted into said outer shell 101, to thereby: (i) prevent unintentional extraction of said inner container 102 from said outer shell 101 when residing therein; and (ii) prevent twisting of said inner container 102 to enable screwing off and on said lid 103 without actually holding said inner container 102; and
the container has two configurations:
   a first configuration in which: said inner rigid container 102 resides reversibly within said outer shell 101, thereby enabling screwing the lid 103 off and allowing withdrawal of said photosensitive material with minimum exposure to light, as well as screwing the lid 103 back on,
   wherein the lid 103, when screwed on the inner container 102 (that resided within said outer shell 101) presses dedicated protrusion(s) 104 located at the open upper-end of the outer shell 101 against the inner container 102 to thereby reduce the risk of unintentional extraction of said inner container 102 from said outer shell 101, and
   said lid 103 together with said outer shell 101 create a light-impermeable casing that protect the inner container 102 that resided therewithin; and
   a second configuration in which the inner container 102 can be pulled out from the outer shell 101 with the lid 103 still attached thereto, thereby enabling evaluating the amount of material therewithin while avoiding unintentional spillage of its content and its exposure to air and contaminants.

### BRIEF DESCRIPTION OF DRAWINGS

FIG. 1 illustrates one possible configuration of the three components constituting the container of the invention.

FIGS. 2A-2B illustrate how the container of the invention can be used: FIG. 2A—shows that the inner container can be extracted from the outer shell for enabling to see its content; and FIG. 2B—shows that the lid can be opened while the inner container is kept within the opaque outer shell, in order to extract/withdraw its content.

FIG. 3 illustrates possible protrusions located at the open-end of the outer shell, which are designed to secure the lid and thus prevent unintentional extraction of the inner container from the outer shell.

FIG. 4 illustrates other possible protrusions located at the open-end of the outer shell, which are designed to secure the inner container and prevent unintentional extraction thereof from the outer shell, as well as enable twisting the lid open without twisting the inner container located within the outer shell.

### DETAILED DESCRIPTION OF THE INVENTION

Photosensitive materials, drugs and compositions containing active agents/ingredients that are photosensitive, experience lessened efficacy, or even a complete loss of efficacy, after exposure to certain light wavelengths (e.g. visible light spectrum or ultraviolet rays). This is usually due to chemical or photochemical reactions that result in the degradation and/or impairment of desired properties of said agents. Thus, it is important for such photosensitive materials to be housed in a container that shields them from exposure to light. At the same time, however, the user of such photosensitive materials often needs/desires to see the contents of the container, e.g. to evaluate how much material is left, and whether there is enough for immediate or future use, or whether there is a need to order more material, and/or to examine the content for potential contamination (e.g. see cloudiness or floating substance therein).

When said photosensitive material is an analyte, such undesirable circumstances may lead to erroneous results or inconclusive data that may lead to wrong conclusions and/or force to repeat the experiment. In other situations, such unfavorable light conditions may even be life threatening, e.g. when analyzing bilirubin content (which is very sensitive to light in the visible spectrum) in a blood sample.

Accordingly, the present invention provides a container for holding a photosensitive material, which both protects the material therewithin from light in all wavelengths as well as enables the user to observe its content. A container according to the invention comprises: (a) a light-impermeable/opaque rigid outer shell 101 comprising a sealed bottom-end and an open upper-end; (b) an inner rigid container 102 comprising a sealed bottom-end and an open upper-end, wherein at least part of said inner container 102 is transparent; and (c) a light-impermeable/opaque lid 103 designed to (connect and) seal said inner container 102, wherein, when said lid 103 seals said inner container 102, and said inner container 102 is placed within said outer shell 101, said outer shell 101 interlock with either said lid 103 or said inner container 102, and said lid 103 together with said outer shell 101 creates a light-impermeable casing.

In specific embodiments, the container of the invention for holding a photosensitive material, comprises: (a) a light-impermeable rigid outer shell 101 comprising a sealed bottom-end and an open upper-end; (b) an inner rigid container 102 comprising a sealed bottom-end and an open upper-end, wherein at least part of said inner container 102 is transparent; and (c) a light-impermeable lid 103 designed to screw onto and seal said inner container 102, wherein:
said light-impermeable rigid outer shell 101 and said inner container 102 comprise complementary protrusions 106 and grooves 107 designed to fit one another when said inner container 102 is inserted into said outer shell 101, to thereby: (i) prevent unintentional extraction of said inner container 102 from said outer shell 101 when residing therein; and (ii) prevent twisting of said inner container 102 to enable screwing off and on said lid 103 without actually holding said inner container 102; and
the container has two configurations:
   a first configuration in which: said inner rigid container 102 resides reversibly within said outer shell 101, thereby enabling screwing the lid 103 off and allowing withdrawal of said photosensitive material with minimum exposure to light, as well as screwing the lid 103 back on,
   wherein the lid 103, when screwed on the inner container 102 (that resided within said outer shell 101) presses dedicated protrusion(s) 104 located at the open upper-end of the outer shell 101 against the inner container 102 to thereby reduce the risk of unintentional extraction of said inner container 102 from said outer shell 101, and
   said lid 103 together with said outer shell 101 create a light-impermeable casing that protect the inner container 102 that resided therewithin; and
   a second configuration in which the inner container 102 can be pulled out from the outer shell 101 with the lid 103 still attached thereto, thereby enabling evaluating the amount of material therewithin while avoiding unintentional spillage of its content and its exposure to air and contaminants.

The term “light-impermeable” is used herein interchangeably with the term “opaque” and means that light at different wavelengths cannot pass therethrough.

It should be noted that the term “comprising” is used herein interchangeably with the term “having”.

In certain embodiments, the transparency of said inner container 102 or its transparent regions, is determined or constructed according to the photosensitivity of the material stored therein. For instance, if the material is sensitive to UV light, the container 102 may be darkened in such a way that UV wavelengths (e.g. 10-200; 200-380; and 200-400) are blocked, but the content remains visible to the naked eye (e.g. “brown glass”).

Accordingly, in specific embodiments, the inner container 102 of the container of the invention is completely transparent. In other specific embodiments, at least ⅔ of the length of said inner container 102, starting from its sealed bottom-end, is transparent. In alternative specific embodiments, about a ⅓ of the length of said inner container 102, starting from its open upper-end, is opaque.

In other specific embodiments, the inner container 102 of the container assembly of the invention is opaque expect for one or more transparent stripes extending, e.g., from its open upper-end to its sealed bottom-end. Said strips may extend from the inner container's sealed bottom-end to about ⅔ of its length.

According to some embodiments, the container of the invention is designed such that the rigid outer shell 101 together with the opaque lid 103 create a light impermeable and sealed casing that completely prevents light from entering and reaching the inner container 102 resides therein. In this way, any photosensitive material present in said inner container 102 located within said outer shell 101, is thus completely light protected. However, in case a person needs to observe the content of the material—either to examine its clarity or cleanliness, or to evaluate its remaining amount, the inner container 102 can be easily extracted out of said outer shell 101 to thereby enabling such observation. In certain embodiments, the inner container 102 is extracted while the lid 103 is still attached thereto, thereby preventing unintentional spillage of its content. In other embodiments, the inner container 102 is extracted without the lid 103, which optionally remains attached to the outer shell 101.

In addition, when it is desired to withdraw some or all of the photosensitive material from the inner container 102, it can be done by opening the lid 103 while the inner container 102 still resided within said outer shell 101, thereby maintaining maximal light protection in the absence of the lid 103. Notably, the protrusions 106 and grooves 107 of the container affix the inner container in place thus enabling the opening and the removal of the lid 103 from the inner container 102 without the need to physically hold/touch the inner container 102 or the need to extract it from the outer shell 101.

Accordingly, in certain embodiments of the container of the invention said inner container 102 is attached removably to said outer shell 101 by any suitable mechanism. Non-limiting examples of such suitable mechanisms are: clip-on(s); extensions fitted into grooves or a rail(s); clips; friction (i.e. the materials from which said inner container 102 and said outer shell 101 are made of enable friction thus prevent unintentional separation of the two); screw mechanism (e.g. between the lid 103 and the outer shell 101, or between the inner container 102 and the outer shell 101); a space within the lid 103 into which said outer shell 101 enters and interlocks; an O-ring located either inside said outer shell 101 or onto said inner container 102; or any other mechanism that prevents unintentional extraction of said inner container 102 from said outer shell 101, while enabling easy extraction thereof when needed.

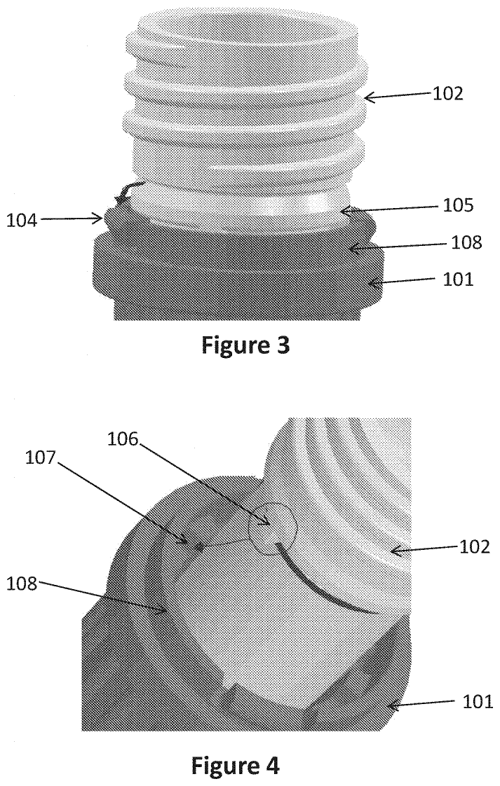

In specific embodiments, and as illustrated in FIG. 3, the outer shell 101 comprises at least one protrusion 104 and said inner container 102 comprises complementing attachment region(s) 105 designed to fit/embrace said at least one protrusion 104, to thereby prevent unintentional extraction of said inner container 102 from said outer shell 101. In specific embodiments, when the lid 103 is (screwed-) on, it applies pressure on said at least one protrusion 104 and presses it against said complementing attachment region(s) 105, to thereby increase the safety and reduce the risk of unintentional extraction of the inner container 102 from the outer shell 101.

In specific embodiments, the outer shell 101 comprises at least one protrusion 104 and said lid 103 comprises complementing attachment region(s) designed to embrace said at least one protrusion 104 when the lid 103 is on, to thereby prevent unintentional extraction of said inner container 102 from said outer shell 101.

In another specific embodiment, and as illustrated in FIG. 4, said inner container 102 comprises at least one protrusion 106 and said outer shell 101 comprises complementing rail 107 or attachment region(s) designed to embrace said at least one protrusion 106, to thereby prevent unintentional extraction of said inner container 102 from said outer shell 101. In specific embodiments, said inner container 102 comprises two, three or four protrusion 106 evenly distributed across it perimeter, and said outer shell 101 comprises complementing rail 107 across its entire inner perimeter designed to embrace said protrusions 106.

In another specific embodiment, said lid 103 comprises at least one protrusion and said outer shell 101 comprises complementing rail or attachment region(s) designed to embrace said at least one protrusion, to thereby prevent unintentional extraction of said inner container 102 from said outer shell 101.

In certain embodiments, the lid 103 of the container of the invention is associated with the inner container 102 permanently, e.g. as a flip-on. In an alternative embodiment, the lid 103 is associated with the inner container 102 in a removable manner, e.g. via a screw mechanism, and optionally does not associate with the outer shell 101.

In specific embodiments, and as illustrated in FIGS. 3 and 4, the outer shell 101 of the container assembly of the invention has an extension 108 at the perimeter of its open upper-end, and when said inner container 102 with the lid 103 attached thereto is located within said outer shell 101, the lid 103 overlaps said extension 108, so as to completely block light from penetrating and reaching said inner container 102. Alternatively, the lid 103 has an extension designed to overlap with the perimeter of the outer shell 101 (either internally or externally), such that when said inner container 102 with the lid 103 attached thereto is located within said outer shell 101, light is blocked from penetrating and reaching said inner container 102.

In certain embodiments, the container assembly of the invention may have any size and form, as long as it includes an external opaque rigid outer shell, an inner container for holding a (photosensitive) material, and a lid. For instance, the container of the invention may be in the shape and size of a standard Eppendorf/vial, a Petri dish, a tube (e.g. 10 cc, 15 cc, 50 cc, etc.), a test tube, a bottle, a microwell, a titer plate, a flask, a beaker, a bucket, etc. Accordingly, a container assembly of the invention may have a square, rectangular, circular, triangular, spherical shape or the like. In certain embodiments, the container of the invention has an external shape and size similar or identical to existing, non-light-protective containers, so it fits standard racks, centrifuges, or any other storing or placing means.

In certain embodiments, the outer shell 101 of the container of the invention may further include an attachment element for attaching the container to a rack, housing, or the like. The attachment element may be any form of attachment element known in the art, such as but not limited to a screw mechanism, snap, draw string, button element, or the like. The outer shell 101 may also include a sensor indicator for indicating the temperature of its content (for instance, a thermo strip), and/or identification means for aiding in determining the content of the container (type, hazardousness, sensitivity, shelf life, etc.).

A container of the invention may be constructed in any manner and from any suitable material, usually including those used in the fabrication industry for the manufacture of biological and/or chemical holding articles. Accordingly, the outer shell 101, said inner container 102, and said lid 103 of the container of the invention may each, independently, be made of: plastic, glass, various polymers, polypropylene, polyethylene, thylene or propylene, or any combination thereof.

In certain embodiments, e.g. when the outer shell 101 and the inner container 102 of the container of the invention are both made of glass, they are attached removably to one another by a suitable mechanism selected from: friction; screw mechanism; a space within the lid 101 into which said outer shell 101 enters and interlocks; an O-ring located either inside said outer shell 101 or onto said inner container 102; or any other suitable mechanism that both prevents unintentional separation of the inner container 102 from the outer shell 101, and prevents damage to the glass, or any combination thereof.

In other embodiments, the outer shell 101 and the inner container 102 are both made of polypropylene and/or polyethylene, and are attached removably to one another by a suitable mechanism selected from: clip-on(s); extensions fitted into grooves or a rail(s); clips; friction; screw mechanism; a space within the lid 101 into which said outer shell 101 enters and interlocks; an O-ring located either inside said outer shell 101 or onto said inner container 102, or any other suitable mechanism that prevents unintentional separation of the inner container 102 from the outer shell 101, or any combination thereof.

In yet other embodiments, the outer shell 101 and the inner container 102 are made of two different materials, e.g. one from glass and the other from polypropylene and/or polyethylene, and are attached removably to one another by any suitable mechanism(s).

It should be noted that the lid 103 may also be made of any suitable material, regardless of the material the outer shell 101 and the inner container 102 are made of.

The contained photosensitive material may include a sample, a ligand, an analyte, or other material to be tested. Hence, a container assembly of the invention holding such photosensitive material is also contemplated by the present invention.

The invention will now be illustrated by the following non-limiting examples with reference to the accompanying drawings.

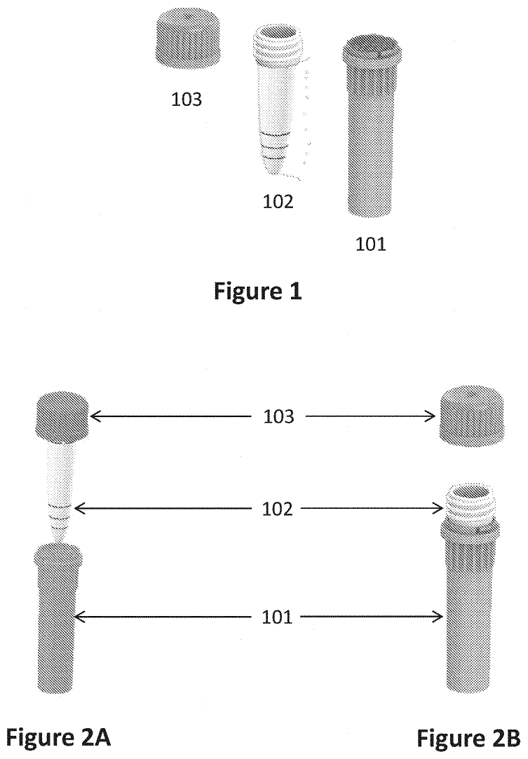

FIG. 1 illustrates the three components of a container according to some embodiments of the invention, showing an outer shell 101, an inner container 102 with a screw mechanism at its open end, and a lid 103 with an internal screw mechanism (not shown) fitting the screw mechanism of the inner container 102.

FIG. 2 illustrates the two main alternative assembly configurations of a container according to the invention, reflecting on the unique characteristics of the container: In a first configuration, as seen in FIG. 2A, the inner container 102, optionally having amount indicators (the lines at its bottom), can be pulled out from the outer shell 101 with the lid 103 still attached thereto, thereby enabling evaluating the amount of material within while avoiding unintentional spillage of its content and without exposing the content to air and possible contaminants. In a second configuration, as seen in FIG. 2B, the inner container 102 remains inside the outer shell 101, and only the lid 103 is removed therefrom, thereby allowing withdrawal of the photosensitive material with minimum exposure to light. Notably, the removal/unscrewing of the lid 103 from the inner container 102 is carried out without touching the inner container 102 and without extracting it from the outer shell 101. As explained above, the screw mechanism of the inner container 102 may be made-of or coated-with opaque material to increase light blockage even when the lid 103 is removed.

FIG. 3 illustrates how the inner container 102 is locked in the outer shell 101 by an interaction between protrusions 104 which constitute part of the outer shell 101, with a dedicated attachment region (e.g. a rail or recess) 105 which constitutes part of the inner container 102: Once the inner container 102 is inserted into the outer shell 101, the attachment region 105 and the protrusions 104 interlock and prevent unintentional separation. However, separation can be carried out by minor application of force—either directly pulling the inner container 102 or by slightly twisting it in order to release the attachment region 105 from the protrusions 104. In specific embodiments, the lid 103, when placed/screwed on the inner container 102 that resides within the outer shell 101, applies pressure onto said protrusions 104 and thus further increases the locking ability and reduces the risk of unintentional extraction thereof.

Accordingly, in certain embodiments, the outer shell 101 comprises one, two, three, four or more protrusions 104, and said inner container 102 comprises at least one attachment region 105 or a set of attachment regions designed to fit said protrusions 104 when said inner container 102 is inserted into said outer shell 101, to thereby prevent unintentional extraction of said inner container 102 from said outer shell 101.

In an alternative embodiment, the inner container 102 comprises one, two, three, four or more protrusions 104, and said outer shell 101 comprises at least one attachment region 105 or a set of attachment regions designed to fit said protrusions 104 when said inner container 102 is inserted into said outer shell 101, to thereby prevent unintentional extraction of said inner container 102 from said outer shell 101. In yet another specific embodiment of this configuration, the lid 103, when placed/screwed on the inner container 102 that resides within the outer shell 101, applies pressure onto said attachment region(s) 105 and thus further increases the locking ability and reduces the risk of unintentional extraction thereof.

FIG. 4 illustrates yet another interlocking configuration designed to increase safety by both reducing the risk of unintentional extraction, and enable screwing the lid 103 off and on the inner container without touching the inner container 102 or extracting it from the outer shell 101: As illustrated in FIG. 4, the outer shell 101 may comprise a set of grooves 107 and the inner container 102 may comprise corresponding protrusions 106 that can fit into said grooves 107 when the inner container 102 is inserted into the outer shell 101. Once inside, the grooves 107 prevent the inner container from twisting inside the outer shell 101, thereby enabling twisting the lid 103 for opening and closing the inner container 102. In certain embodiments, the interaction between said grooves 107 and said protrusions 106 also assists in preventing unintentional extraction of the inner container 102 from the outer shell 101, and come instead or in addition to the above described attachment region 105 and its corresponding protrusions 104.

Accordingly, in certain embodiments, the inner container 102 comprises one, two, three, four or more protrusions 106 located at its upper-end, and said light-impermeable rigid outer shell 101 comprises a set of grooves 107 or rail(s) designed to fit said protrusions 106 when said inner container 102 is inserted into said outer shell 101, to thereby: (i) prevent unintentional extraction of said inner container 102 from said outer shell 101; or (ii) enable fixating said inner container 102 to enable opening and closing, e.g. by twisting, flipping, etc., said lid 103 without actually touching/holding said inner container 102, or both.

In an alternative embodiment, the inner container 102 comprises one, two, three, four or more protrusions 106 located at its bottom-end, and said light-impermeable rigid outer shell 101 comprises a set of grooves 107 located at its bottom-end designed to fit said protrusions 106 when said inner container 102 is inserted into said outer shell 101, to thereby: (i) prevent unintentional extraction of said inner container 102 from said outer shell 101; or (ii) enable fixating said inner container 102 to enable opening and closing, e.g. by twisting, flipping, etc., said lid 103 without actually touching/holding said inner container 102, or both.

In yet another alternative embodiment, the outer shell 101 comprises one, two, three, four or more protrusions 106, and said inner container 102 comprises a set of grooves 107 designed to fit said protrusions 106 when said inner container 102 is inserted into said outer shell 101, to thereby: (i) prevent unintentional extraction of said inner container 102 from said outer shell 101; or (ii) enable fixating said inner container 102 to enable opening and closing, e.g. by twisting, flipping, etc., said lid 103 without actually touching/holding said inner container 102, or both.

1) A container for holding a photosensitive material, said container comprising:
a) a light-impermeable rigid outer shell 101 comprising a sealed bottom-end and an open upper-end;
b) an inner rigid container 102 comprising a sealed bottom-end and an open upper-end, wherein at least part of said inner container 102 is transparent; and
c) a light-impermeable lid 103 designed to connect and seal said inner container 102,
wherein, when said lid 103 seals said inner container 102, and said inner container 102 is placed within said outer shell 101, said outer shell 101 interlocks with either said lid 103 or said inner container 102, and said lid 103 together with said outer shell 101 create a light-impermeable casing.

2) The container of claim 1, wherein said inner container 102 is attached removably to said outer shell 101 by any suitable mechanism.

3) The container of claim 2, wherein said suitable mechanism is any one of: clip-on(s); extensions fitted into grooves or a rail(s); clips; friction; screw mechanism; a space within the lid 103 into which said outer shell 101 enters and interlocks; an O-ring located either inside said outer shell 101 or onto said inner container 102; etc.

4) The container of any one of claims 1-3, wherein said outer shell 101 comprises at least one protrusion and said lid 103 comprises complementing attachment region(s) designed to embrace said at least one protrusion, to thereby prevent unintentional extraction of said inner container 102 from said outer shell 101.

5) The container of any one of claims 1-3, wherein said outer shell 101 comprises at least one protrusion and said inner container 102 comprises complementing attachment region(s) designed to embrace said at least one protrusion, to thereby prevent unintentional extraction of said inner container 102 from said outer shell 101.

6) The container of any one of claims 1-5, wherein said lid 103 comprises at least one protrusion and said outer shell 101 comprises complementing rail or attachment region(s) designed to embrace said at least one protrusion, to thereby prevent unintentional extraction of said inner container 102 from said outer shell 101.

7) The container of any one of claims 1-5, wherein said inner container 102 comprises at least one protrusion and said outer shell 101 comprises complementing rail or attachment region(s) designed to embrace said at least one protrusion, to thereby prevent unintentional extraction of said inner container 102 from said outer shell 101.

8) The container of any one of claims 1-7, wherein said lid 103 is associated with said inner container 102 permanently.

9) The container of any one of claim 1-7, wherein said lid 103 is associated with said inner container 102 in a removable manner.

10) The container of claim 9, wherein said lid 103 is designed to screw onto and seal said inner container 102, and wherein:
when said lid 103 seals said inner container 102, and said inner container 102 is placed within said outer shell 101, said outer shell 101 interlocks with said lid 103 and/or said inner container 102, and said lid 103 together with said outer shell 101 creates a light-impermeable casing, and
when said inner container 102 is placed within said outer shell 101, it is affixed so that said lid 103 can be screwed on or off without extracting said inner container 102 from said outer shell 101.

11) The container of claim 9 or 10, wherein said lid 103 is designed to screw onto and seal said inner container 102, and wherein the container has two configurations:
a first configuration in which said inner rigid container 102 resides reversibly within said outer shell 101, thereby enabling screwing the lid 103 off and allowing withdrawal of said photosensitive material with minimum exposure to light, as well as screwing the lid 103 back on; and
a second configuration in which the inner container 102 can be pulled out from the outer shell 101 with the lid 103 still attached thereto, thereby enabling evaluating the amount of material therewithin while avoiding unintentional spillage of its content and its exposure to air.

12) The container of any one of claims 9-11, wherein said inner container 102 is attached removably to said outer shell 101 by any one of the following mechanisms: clip-on(s); extensions fitted into grooves or a rail(s); clips; screw mechanism; a space within the lid 103 into which said outer shell 101 enters and interlocks; or a combination thereof.

13) The container of any one of claims 1-12, wherein said outer shell 101 has an extension 108 at the perimeter of its open upper-end, and said lid 103, when said inner container 102 is located within said outer shell 101, overlaps said extension 108, so as to completely block light from penetrating and reaching said inner container 102.

14) The container of any one of claims 1-12, wherein said lid 103 has an extension 108 designed to overlap with the perimeter of said outer shell 101 such that when said inner container 102 with the lid 103 attached thereto, is located within said outer shell 101, light is blocked from penetrating and reaching said inner container 102.

15) The container of any one of claims 1-14, wherein said inner container 102 comprises one, two, three, four or more protrusions located at its upper-end, and said light-impermeable rigid outer shell 101 comprises a set of grooves or rail(s) designed to fit said protrusions when said inner container 102 is inserted into said outer shell 101, to thereby: (i) prevent unintentional extraction of said inner container 102 from said outer shell 101; or (ii) enable fixating said inner container 102 to enable opening and closing said lid 103 without actually touching/holding said inner container 102, or both.

16) The container of any one of claims 1-14, wherein said inner container 102 comprises one, two, three, four or more protrusions located at its bottom-end, and said light-impermeable rigid outer shell 101 comprises a set of grooves 107 located at its bottom-end designed to fit said protrusions 106 when said inner container 102 is inserted into said outer shell 101, to thereby: (i) prevent unintentional extraction of said inner container 102 from said outer shell 101; or (ii) enable fixating said inner container 102 to enable opening and closing said lid 103 without actually touching/holding said inner container 102, or both.

17) The container of any one of claims 9-16, wherein:
said light-impermeable rigid outer shell 101 and said inner container 102 comprise complementary protrusions 106 and grooves 107 designed to fit one another when said inner container 102 is inserted into said outer shell 101, to thereby: (i) prevent unintentional extraction of said inner container 102 from said outer shell 101 when residing therein; and (ii) prevent twisting of said inner container 102 to enable screwing off and on said lid 103 without actually holding said inner container 102; and
the container has two configurations:
a first configuration in which said inner rigid container 102 resides reversibly within said outer shell 101, thereby enabling screwing the lid 103 off and allowing withdrawal of said photosensitive material with minimum exposure to light, as well as screwing the lid 103 back on, wherein the lid 103, when screwed on the inner container 102 presses dedicated protrusion(s) 104 to thereby reduce the risk of unintentional extraction of said inner container 102 from said outer shell 101, and said lid 103 together with said outer shell 101 create a light-impermeable casing that protect the inner container 102 that resided therewithin; and
a second configuration in which the inner container 102 can be pulled out from the outer shell 101 with the lid 103 still attached thereto, thereby enabling evaluating the amount of material therewithin while avoiding unintentional spillage of its content and its exposure to air and contaminants.

18) The container of any one of claims 1-17, wherein said outer shell 101, said inner container 102, and said lid 103 are each independently made of: plastic, glass, various polymers, polypropylene, polyethylene, thylene or propylene, or any combination thereof.

19) The container of claim 18, wherein said outer shell 101 and said inner container 102 are both made of glass.

20) The container of claim 19, wherein said outer shell 101 and said inner container 102 are attached removably to one another by a suitable mechanism selected from: friction; screw mechanism; a space within the lid 103 into which said outer shell 101 enters and interlocks; and an O-ring located either inside said outer shell 101 or onto said inner container 102.

21) The container of claim 18, wherein said outer shell 101 and said inner container 102 are both made of polypropylene and/or polyethylene.

22) The container of claim 21, wherein said outer shell 101 and said inner container 102 are attached removably to one another by a suitable mechanism selected from: clip-on(s); extensions fitted into grooves or a rail(s); clips; friction; screw mechanism; a space within the lid 103 into which said outer shell 101 enters and interlocks; and an O-ring located either inside said outer shell 101 or onto said inner container 102.

23) The container of claim 18, wherein said outer shell 101 and said inner container 102 are made of two different materials.

24) The container of any one of claims 1-23, wherein said inner container 102 is completely transparent.

25) The container of any one of claims 1-23, wherein at least ⅔ of the length of said inner container 102, starting from its sealed bottom-end, is transparent.

26) The container of any one of claims 1-23, wherein about a ⅓ of the length of said inner container 102, starting from its open upper-end, is opaque.

27) The container of any one of claims 1-23, wherein said inner container 102 is opaque expect for a transparent stripe extending from its open upper-end to its sealed bottom-end.

28) A container for holding a photosensitive material, said container comprising:
a) a light-impermeable rigid outer shell 101 comprising a sealed bottom-end and an open upper-end;
b) an inner rigid container 102 comprising a sealed bottom-end and an open upper-end, wherein at least part of said inner container 102 is transparent; and
c) a light-impermeable lid 103 designed to screw onto and seal said inner container 102,
wherein:
said light-impermeable rigid outer shell 101 and said inner container 102 comprise complementary protrusions 106 and grooves 107 designed to fit one another when said inner container 102 is inserted into said outer shell 101, to thereby: (i) prevent unintentional extraction of said inner container 102 from said outer shell 101 when residing therein; and (ii) prevent twisting of said inner container 102 to enable screwing off and on said lid 103 without actually holding said inner container 102; and
the container has two configurations:
a first configuration in which: said inner rigid container 102 resides reversibly within said outer shell 101, thereby enabling screwing the lid 103 off and allowing withdrawal of said photosensitive material with minimum exposure to light, as well as screwing the lid 103 back on,
wherein the lid 103, when screwed on the inner container 102 presses dedicated protrusion(s) 104 located at the open upper-end of the outer shell 101 against the inner container 102 to thereby reduce the risk of unintentional extraction of said inner container from said outer shell 101, and said lid 103 together with said outer shell 101 create a light-impermeable casing that protect the inner container 102 that resided therewithin; and
a second configuration in which the inner container 102 can be pulled out from the outer shell 101 with the lid 103 still attached thereto, thereby enabling evaluating the amount of material therewithin while avoiding unintentional spillage of its content and its exposure to air and contaminants.

29) The container of claim 28, wherein said outer shell 101 comprises at least one protrusion and said lid 103 comprises complementing attachment region(s) designed to embrace said at least one protrusion, to thereby prevent unintentional extraction of said inner container 102 from said outer shell 101.

30) The container of claim 28, wherein said lid 103 comprises at least one protrusion and said outer shell 101 comprises complementing rail or attachment region(s) designed to embrace said at least one protrusion, to thereby prevent unintentional extraction of said inner container 102 from said outer shell 101.
